(19) United States
(12) Patent Application Publication
(10) Pub. No.: US 2017/0168134 A1
(43) Pub. Date: Jun. 15, 2017

(54) Object Detection

(71) Applicant: QUALCOMM Incorporated, San Diego, CA (US)

(72) Inventor: Jatupum Jenwatanavet, San Diego, CA (US)

(21) Appl. No.: 15/012,180

(22) Filed: Feb. 1, 2016

Related U.S. Application Data
(60) Provisional application No. 62/265,478, filed on Dec. 10, 2015.

(51) Int. Cl. G01S 5/06; G01S 5/02; H04W 4/00

(52) U.S. Cl. CPC G01S 5/06; H04W 4/008; G01S 5/0273; H04W 84/12

(57) ABSTRACT

Methods and devices of various embodiments enable determining a location of a remote object using radio frequency signal transmitted from a transmitter on a frame and received at four receivers located at separate locations on the frame. First, second, third, and fourth reflected signals from a remote object may be received at first, second, third, and fourth receivers respectively. Times at which the first, second, third, and fourth reflected signals are received respectively by the first, second, third, and fourth receivers may be determined. The remote object's location may be determined based on the determined times at which the first, second, third, and fourth reflected signals were received respectively and the locations on the frame of the first, second, third, and fourth receivers.

### RELATED APPLICATIONS

This application claims the benefit of priority to U.S. Provisional Application No. 62/265,478 entitled “Object Detection” filed Dec. 10, 2015, the entire contents of which are hereby incorporated by reference.

### BACKGROUND

The ability to detect a position of a remote object has numerous applications, such as for proximity detection, presence detection, warning systems, collision avoidance, and others. Some types of applications, such as unmanned autonomous vehicles (UAVs), may benefit from having the ability to detect nearby objects to enable navigation and collision avoidance, but have limited capacity to carry heavy or bulky equipment (e.g., conventional radar or cameras).

Some conventional radar systems use bi-scattering, which places a transmitter and receiver remote from one another at different locations and on separate devices. The transmitter and receiver exchange signals. The bi-scattering technique may not be used to detect ad-hoc remote objects that do not have either the transmitter or receiver. Other radar system use mono-scattering, which receives a reflected signal at the same antenna from which it was originally transmitted before reflecting off a target. However, mono-scattering systems generally require beam forming, which collimates signals received at the RF receiver or an array of receivers and/or does not use multiple receivers at different locations detecting a timing differential.

### SUMMARY

Various embodiments include a method of determining a location of a remote object including transmitting, from a transmitter at a transmitter location on a frame, a transmission signal, and receiving a first reflected signal, a second reflected signal, a third reflected signal, and a fourth reflected signal at a first receiver, a second receiver, a third receiver, and a fourth receiver respectively. Each of the first, second, third, and fourth reflected signals may be reflections of the transmission signal off the remote object. The first, second, third, and fourth receivers may be disposed on a frame separated from one another respectively at a first receiver location, a second receiver location, a third receiver location, and a fourth receiver location each on the frame. The method may also include determining times at which the first, second, third, and fourth reflected signals are received respectively by the first, second, third, and fourth receivers. The remote object's location may be determined by a processor based on the determined times at which the first, second, third, and fourth reflected signals were received respectively at the first, second, third, and fourth receivers and known locations of the first, second, third, and fourth receivers.

In some embodiments, the transmission signal may include encoding. Determining times at which the first, second, third, and fourth reflected signals received respectively by the first, second, third, and fourth receivers may include determining whether the received first reflected signal, second reflected signal, third reflected signal, and fourth reflected signal include the coding. In addition, times may be determined at which the first, second, third, and fourth reflected signals, including the coding, are received respectively by the first, second, third, and fourth receivers. At the first receiver, the second receiver, the third receiver, and the fourth receiver respectively, a first direct signal, a second direct signal, a third direct signal, and a fourth direct signal may be received, in which the first, second, third, and fourth direct signals are direct receptions of the transmission signal. The remote object's location may be determined in a processor based on the determined times at which the first, second, third, and fourth reflected signals were received respectively at the first, second, third, and fourth receivers. The remote object's location may be determined based on time differences between times at which the first, second, third, and fourth direct signals were each received and the times at which the first, second, third, and fourth reflected signals were each received.

In some embodiments, a first timer, a second timer, a third timer, and a fourth timer respectively may be activated in response to receiving the first, second, third, and fourth direct signals. Activating the first, second, third and fourth receivers to receive reflected signals may follow an expiration of the respective first, second, third and fourth timers. The processor may activate a timer/gate circuit that ignores other signals received at the first, second, third, and fourth receivers within a predetermined period from when the timer/gate circuit is activated. The times the first, second, third, and fourth reflected signals are each received may be received at the processor. Transmitting the transmission signal may include transmitting a wireless local area network (WLAN) communication signal. Transmitting the transmission signal may use a Bluetooth Low Energy (LE) communication signal.

Various embodiments may include a device for detecting a location of a remote object. The device may include a frame and a transmitter, a first receiver, a second receiver, a third receiver, and a fourth receiver all coupled to the frame. The transmitter may be configured to transmit a transmission signal. The first receiver may be coupled to the frame at a first receiver location and configured to receive a first reflected signal generated by a reflection of the transmission signal off the remote object. The second receiver may be coupled to the frame at a second receiver location and configured to receive a second reflected signal generated by the reflection of the transmission signal off the remote object. The third receiver may be coupled to the frame at a third receiver location and configured to receive a third reflected signal generated by the reflection of the transmission signal off the remote object. The fourth receiver may be coupled to the frame at a fourth receiver location and configured to receive a fourth reflected signal generated by the reflection of the transmission signal off the remote object. The first, second, third, and fourth receivers may be separated from one another on the frame. A processor may also be coupled to the transmitter and the first, second, third, and fourth receivers. The processor may be configured to determine the remote object's location based on times that the first, second, third, and fourth reflected signals are received respectively at the first, second, third, and fourth receiver locations.

In some embodiments, the first, second, third, and fourth receivers may each be connected to separate omnidirectional antennas. The transmitter may be configured to transmit a wireless local area network (WLAN) communication signal as the transmission signal. The transmission signal may be a Bluetooth LE communication signal. The transmitter and the first receiver may share an antenna. The frame may be part of an unmanned autonomous vehicle (UAV). At least three of the first, second, third, and fourth receivers may be disposed on separate extension arms of the UAV extending in different directions, wherein the extension arms each support a separate propulsion unit of the UAV.

Further embodiments may include a vehicle frame having means for performing functions of the methods described above. Further embodiments include a non-transitory processor-readable storage medium having stored thereon processor-executable instructions configured to cause a processor to perform operations of the above-discussed methods.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a schematic perspective view of a device for detecting a remote object according to various embodiments.

FIG. 2 is a component block diagram of a device for detecting a remote object according to various embodiments.

FIG. 3A is a graph of a time domain response of a first reflected signal received at a first receiver according to various embodiments.

FIG. 3B is a graph of a time domain response of a second reflected signal received at a second receiver according to various embodiments.

FIG. 3C is a graph of a time domain response of a third reflected signal received at a third receiver according to various embodiments.

FIG. 4 is a process flow diagram illustrating a method of detecting a location of a remote object according to various embodiments.

FIG. 5 is a process flow diagram illustrating a method of filtering received signals according to various embodiments.

FIG. 6A is a perspective view of a device for detecting a remote object in the form of a UAV with equidistant positioned receivers according to various embodiments.

FIG. 6B is a perspective view of a device for detecting a remote object in the form of a UAV with asymmetrically positioned receivers according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include a remote object detection system that locates objects or obstacles in three dimensions base on the times that reflected radio frequency (RF) signals are received by four (or more) spaced-apart RF receivers. The four spaced-apart RF receivers may be positioned at known locations on a frame (e.g., the frame of a UAV) on which a transmitter is positioned and configured to transmit omnidirectional RF signals. RF energy that reflects from an object may be received by each of the four spaced-apart RF receivers at a time that depends upon the separation distances between the object and each RF receiver. Using the time when reflected signals are received by each of the four (or more) RF receivers in combination with the known locations on the frame of the four (or more) RF receivers, processor determines a relative location of or a distance and direction to objects reflecting the transmitted RF signals. Some embodiments include a remote object detection system configured for use on a UAV.

As used herein, the term “frame” refers to a structure, whether unitary or composed of parts fitted together and united, on which are positioned four (or more) RF receivers. An example of a frame is the airframe of a UAV. As used herein, the term “remote object detection system” refers to a system that includes a frame supporting four or more RF receivers and a processor configured to detect the location of a remote object based on reception times of reflected RF signals received by the RF receivers. In some embodiments, a remote object detection system may also include a transmitter of RF signals. For ease of description and illustration, some detailed aspects of the remote object detection system are omitted, such as wiring, various components, frame structure interconnects, or other features that would be known to one of skill in the art.

As used herein the term's “signal” or “RF signal” are used interchangeably to refer to radiated radio waves that are emitted by a transmitter. The term “transmission signal” as used herein refers particularly to those RF signals transmitted by the transmitter of a remote object detection system by way of a transmitting antenna. The transmission signal may have a pulse waveform. A single pulse from the transmitter will propagate away from the transmitter. The terms “reflected signal” and “reflected RF energy” as used herein refer to the portion of transmitted RF signals that are reflected off a remote object and are received by one of the RF receivers.

As used herein, the term “RF receiver” refers to a radio receiver device that receives radio waves captured by an antenna, particularly reflected RF energy. The RF receivers of the various embodiments are configured to determine a time of reception of reflected signals, and may interprets received signals to obtain information encoded within the signals, such as identifying codes.

In various embodiments, a remote object detection system may include a transmitter and four or more RF receivers coupled to a frame, along with a processor configured to calculate locations of objects detected by the system based on information provided by the RF receivers. Transmission signals transmitted by the transmitter propagate through the air and may be scattered by objects. At least a portion of the transmission signal energy (i.e., the reflected signal) will be reflected back toward the frame where the energy may be received by the four (or more) RF receivers. The time that reflected RF signals are received may be noted by each RF receiver. The time between when a signal is transmitted to when the reflected signals are received at each of the four (or more) RF receivers may be determined. Using the speed of light C, the processor may calculate the distances that the RF signals traveled from the transmitter to the objection and back to each of the four (or more) RF receivers. Knowing the location on the frame of each of the four (or more) RF receivers, the processor may calculate the location of the object relative to the frame, or a direction and distance to the object from the frame.

Various embodiments may use an omnidirectional antenna to transmit the transmission signals and omnidirectional antennas for receiving reflected RF signals from all directions. Although RF signals may be received from any direction, the use of differences in reception time noted by each of the four (or more) RF receivers enables determining the location of a reflecting object without the need for a steerable antenna. Thus, various embodiments enable the use of simple antennas that may be lightweight, affordable, and reliable compared to steerable antennas.

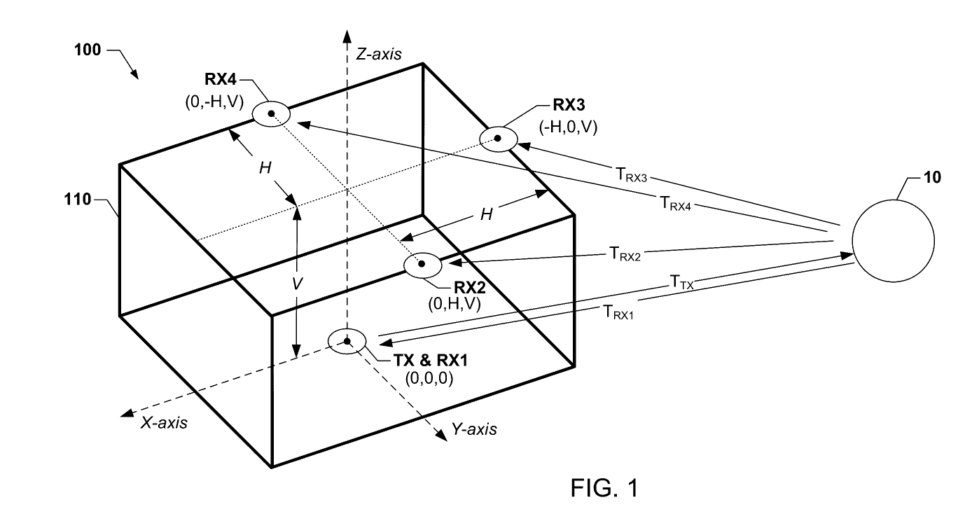

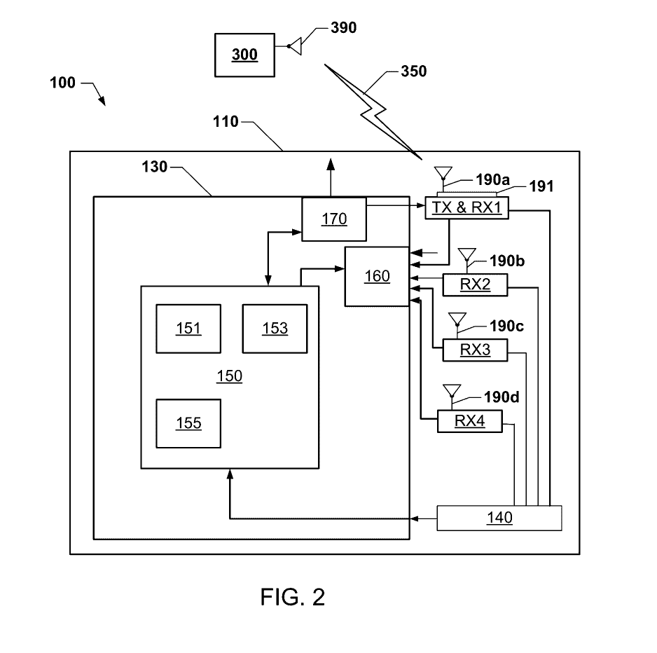

FIG. 1 illustrates an example of a remote object detection system 100 configured to detect a location of a remote object 10 according to various embodiments. The remote object detection system 100 may include at least a transmitter TX, a first receiver RX1, a second receiver RX2, a third receiver RX3, and a fourth receiver RX4 that are each coupled to and held in fixed positions relative to one another by a frame 110 or similar structure that may support the remote object detection system 100. While the frame 110 is illustrated as a three-dimensional block, numerous other shapes or configurations may be used to support the components of a remote object detection system 100 in accordance with various embodiments. The remote object detection system 100 may include a processor 150 (FIG. 2), although the processor 150 and other components may be positioned away from the frame 110, such as an onboard processor or computing device of a UAV.

The remote object detection system 100 is illustrated in FIG. 1 using a three-dimensional Cartesian space having an X-axis, a Y-axis, and a Z-axis, which may be used as a frame of reference for establishing onboard locations of components of the remote object detection system 100, as well as a location of the remote object 10. In some embodiments, the transmitter TX and the first receiver RX1 may be part of a combined transceiver that may use a duplexer to share a single antenna. The second, third, and fourth receivers RX2, RX3, RX4 each use separate antennas and may be receive-only devices.

An origin of the three-dimensional Cartesian space may be anywhere relative to the frame 110 and the transmitter and receiver components thereon. In some embodiments the origin may be coincident with the transmitter location (0,0,0), which is the same as the first receiver location. When the transmitter TX and the first receiver RX1 use a single antenna, that antenna may be considered as having a single point of reference, which is referred to herein as the transmitter location (0,0,0). Each of the second, third, and fourth receivers RX2, RX3, RX4 are positioned at known locations on the frame relative to the transmitter location. For example, in FIG. 1, the second receiver RX2 is positioned at a second receiver location (0,H,V), which corresponds to a zero offset along with the X-axis, a horizontal offset H along the Y-axis, and a vertical offset V the long the Z-axis. Similarly, the third receiver RX3 is illustrated at a third receiver location (−H, 0,V), which corresponds to a horizontal offset H along with the X-axis, a zero offset along the Y-axis, and a vertical offset V the long the Z-axis. Similarly, the fourth receiver RX4 is illustrated positioned at a fourth receiver location (0,−H,V), which corresponds to a zero offset along with the X-axis, a negative horizontal offset H along the Y-axis, and a vertical offset V the long the Z-axis.

In various embodiments, since the speed of the RF signals is the speed of light C, each distance between the RF receiver locations RX1, RX2, RX3, RX4 and the remote object 10 may be determined by measuring a propagation time, which is the time it takes a signal to traverse the distances from the transmitter TX to the remote object 10 and back the respective RF receiver. Thus, the propagation time from a first arbitrary point (x1, y1, z1) to a second arbitrary point (x2, y2, z2) may be expressed as:

{√((x2−x1)̂2+(y2−y1)̂2+(z2−z1)̂2)}/C (1),

where C is the speed of light.

As illustrated in FIG. 1, a transmission signal time T_{TX} corresponds to the distance between the remote object 10 and the transmitter location (0,0,0), which is equal to a first receiver time T_{RX1} corresponding to the same distance. A second receiver time T_{RX2} corresponds to the distance between the remote object 10 and the second receiver location (0,H,V). A third receiver time T_{RX3} corresponds to the distance between the remote object 10 and the third receiver location (−H₂O,V). A fourth receiver time T_{RX4} corresponds to the distance between the remote object 10 and the fourth receiver location (0,−H,V). Thus, the time delays D₁, D₂, D₃, D₄ between when the transmission signal is transmitted from the transmitter location (0,0,0) and when each reflected signals is received at the respective receivers RX1, RX2, RX3, RX4 will be made up of the transmission signal time T_{TX} plus the respective first, second, third, and fourth receiver times T_{RX1}, T_{RX2}, T_{RX3}, T_{RX4}.

Using equation (1), the horizontal offset H, and the vertical offset V, the time delays D₁, D₂, D₃, D₄ may be expressed as follows:

D₁=[\sqrt{x²+y²+z²}+\sqrt{x²+y²+z²}]/C (2A),

D₂=[\sqrt{x²+y²+z²}+\sqrt{x²+(y−H)²+(z-31 V)²}]/C (3A),

D₃=[\sqrt{x²+y²+z²}+\sqrt{(x+H)²+y²+(z+V)²}]/C (4A), and

D₄=[\sqrt{x²+y²+z²}+\sqrt{x²+(y+H)²+(y−V)²}]/C (5A),

where x, y, and z represent unknown distances from the transmitter location (0,0,0) to the object in the three-dimensional Cartesian space illustrated in FIG. 1. If the second, third, and fourth receivers RX2, RX3, RX4 do not have the same horizontal offset H and/or the same vertical offset V, equations (2A)-(5A) may be adapted accordingly via a suitable coordinate transformation. The time delays D₁, D₂, D₃, D₄ may be measured with a clock, such as a clock in each RF receiver or a clock in a processor configured to receive signals from each RF receiver RX1, RX2, RX3, RX4. Also, since the coordinate offsets H, and V defining locations of RF receiver RX2, RX3, RX4 relative the receiver RX1 at the transmitter location are known, equations (2A)-(5A) represent a solvable set of three unknown variables, namely x, y, and z, and four equations. Thus, using the four equations (2A)-(5A) and the known values of H and V, the three unknown variables may be determined.

Elements of equations (2A)-(5A) may be rearranged and expressed as follows:

$$\begin{matrix}\sqrt{{x}^{2} + {y}^{2} + {z}^{2}} = {CD}_{1} / 2 , & ( 2 B ) \\ \sqrt{{x}^{2} + {( y - H )}^{2} + {( z - V )}^{2}} = {CD}_{2} - {CD}_{1} / 2 , & ( 3 B ) \\ \sqrt{{( x + H )}^{2} + {y}^{2} + {( z - V )}^{2}} = {CD}_{3} - {CD}_{1} / 2 , and & ( 4 B ) \\ \sqrt{\begin{matrix}{x}^{2} + {( y + H )}^{2} + \\ {( y - V )}^{2}\end{matrix}} = {CD}_{4} - {CD}_{1} / 2. & ( 5 B )\end{matrix}$$

In addition, the determinable variables A and B may be derived as short-hand from equations (2B)-(5B), associating values that are either known or maybe be determined as follows:

A=CD₂−CD₁/2 and B=CD₃−CD₁/2

Using the determinable variable A, the following additional equation may be derived from equation (3B):

x²+(y−H)²+(z−V)²=A² (6).

Also, using the determinable variable B, the following additional equation may be derived from equation (4B):

(x+H)²+y³²+(z−V)²=B² (7).

Subtracting equation (7) from equation (6), the terms A² and B² may be associated and expressed in accordance with the following equivalent equations:

$$\begin{matrix}{x}^{2} + {( y - H )}^{2} - {( x + H )}^{2} - {y}^{2} = {A}^{2} - {B}^{2} , & ( 8 A ) \\ {x}^{2} + {y}^{2} + {H}^{2} - 2 yH - {x}^{2} - 2 xH - {H}^{2} - {y}^{2} = {A}^{2} - {B}^{2} , & ( 8 B ) \\ - 2 H ( y + x ) = {A}^{2} - {B}^{2} , and & ( 8 C ) \\ x + y = \frac{{B}^{⋀} 2 - {A}^{⋀} 2}{2 H} . & ( 8 D )\end{matrix}$$

Additional determinable variables E, F, and G may be derived as further short-hand associating values that are either known or may be determined as follows:

$$E = \frac{{B}^{⋀} 2 - {A}^{⋀} 2}{2 H} , F = {CD}_{1} / 2 , and G = {CD}_{4} - {CD}_{1} / 2.$$

Using the determinable variable G, the following additional equation may be derived from equation (5B):

x²+(y+H)²+(z−V)²=G² (9).

Subtracting equation (9) from equation (6), the terms A² and G² may be associated and expressed in accordance with the following equivalent equations, which solves for the variable y:

$$\begin{matrix}{x}^{2} + {( y - H )}^{2} - {x}^{2} - {( y + H )}^{2} = {A}^{2} - {G}^{2} , & ( 10 A ) \\ {y}^{2} - 2 yH + {H}^{2} - {y}^{2} - 2 yH - {H}^{2} = {A}^{2} - {G}^{2} , & ( 10 B ) \\ - 4 yH = {A}^{2} - {G}^{2} , and & ( 10 C ) \\ y = \frac{{G}^{⋀} 2 - {A}^{⋀} 2}{4 H} . & ( 10 D )\end{matrix}$$

Substituting equation (10D) into equation (8D), the variable x may be expressed as follows :

x=((B²−A²)/2H)−((G²−A²)/4H) (11).

From equation (2B), the square of the variable F may be expressed as follows:

x²+y²+z²=F² (12).

Subtracting equation (12) from equation (6), the terms A² and F² may be associated and expressed in accordance with the following equivalent equations, which solves for the variable z:

x²+(y−H)²+(z−V)²−x²−y²−z²=A²−F² (13A),

x²+y²−2yH+H²+z²−2zV+V²−x²−y²−z²=A²−F² (13B),

−2yH+H²−2zV+V²=A²−F² (13C),

H²+V²−2yH=A²−F²+2zV (13D), and

z=(H²+V²−2yH−A²+F²)/2V (13E).

Thus, equations (11), (10D), and (13E) may be used to determine respectively the variables x, y, and z, which provide the coordinates of the remote object 10 relative to the transmitter location (0,0,0) in the remote object detection system 100.

The calculation described above may be adjusted through suitable coordinate transformations and variable adjustments to accommodate a variety of different RF receiver and transmitter layouts. For example, the transmitter TX need not be co-located with one of the RF receivers, and may positioned off of the frame and at different distances from each of the RF receivers RX1, RX2, RX3, RX4, provided that those separation distances are known, by making corresponding linear changes to the equations as would be understood by one of ordinary skill in geometry. Thus, the calculations described above intended as an example of the types of calculations that would be accomplished by a processor of a remote object detection system, but are not intended to be limiting.

A wide range of vehicles and applications may make use of a remote object detection system (e.g., 100) according to various embodiments. Some non-limiting examples of vehicles and applications that may utilize a remote object detection system include machinery, aeronautical vehicles, aerospace vehicles, motor vehicles, waterborne vehicles, medical devices, robots, toys, appliances, electronics, and any apparatus that might benefit from object detection.

FIG. 2 is a component block diagram of a remote object detection system 100 according to various embodiments. With reference to FIGS. 1-2, the remote object detection system 100 may include the frame 110 supporting the transmitter TX, the first receiver RX1, the second receiver RX2, the third receiver RX3, and the fourth receiver RX4. The first, second, third, and fourth receivers RX1, RX2, RX3, RX4 may each be coupled to a first, second, third, and fourth antenna 190a, 190b, 190c, 190d, respectively. In some embodiments, the transmitter TX and the first receiver RX1 may share the first antenna 190a (e.g., using a duplexer 191).

The remote object detection system 100 may include a power module 140 and a control unit 130 that may house various circuits and devices used to power and control the operation of the remote object detection system 100. The control unit 130 may include a processor 150, an input module 160, and an output module 170. The processor 150 may include or be coupled to memory 151 and other circuit elements, such as an encoder 153 or a time gating circuit/module 155. The processor 150 may be configured with processor-executable instructions to perform operations of the remote object detection system 100, including operations of the various embodiments.

The power module 140 may include one or more batteries that may provide power to various components, including the processor 150, the input module 160, the output module 170, the radio modules including the transmitter TX, and the first, second, third, and fourth receivers RX1, RX2, RX3, RX4. In addition, the power module 140 may include energy storage components, such as rechargeable batteries. The processor 150 may be configured with processor-executable instructions to control the charging of the power module 140. Alternatively or additionally, the power module 140 may be configured to manage its own charging. The processor 150 may be coupled to an output module 170, which may output control signals for managing the motors and other components.

In some embodiments, the transmitter TX and the first receiver RX1 may be configured to transmit and/or receive more than just signals for object detection, and may function as a communication system for transmitting/receiving information, instructions, and/or data. The RF receiver RX1 may pass received information, instructions, and/or data to the processor 150 to assist in operation of the remote object detection system 100.

For example, communication signals 350 may be received via the first receiver RX1 from a remote communication device 300. The remote communication device 300 may be any of a variety of wireless communication devices (e.g., smartphones, laptops, tablets, smartwatches, etc.). In some embodiments, the remote communication device 300 may include a processor (not shown) configured to collect the information and perform the computations needed for determining a location of a remote object. The remote communication device 300 may have one or more radio signal transceivers 390 (e.g., WLAN) and antenna for sending and receiving communications, coupled to the processor. The remote communication device 300 may include a cellular network wireless modem chip coupled to the processor that enables communication via a cellular network. Thus, the processor performing calculations to determine a location of a remote object based upon reflected RF signal receipt times may be in a separate computing device that is in communication with the remote object detection system 100. In addition, the communication signals 350 may include input from a knowledge base regarding remote objects, current conditions, a current orientation of the remote object detection system 100 or elements thereof, predicted future conditions, or other information that may be used in connection with remote object detection and/or operation of the remote operation device.

In various embodiments, the transmitter TX and/or any one of the first, second, third, and fourth receivers RX1, RX2, RX3, RX4 may be configured to switch between different forms of RF communication, referred to as radio access technologies (RATs), such as cellular communications, WLAN communications, or other forms of radio connection. Different RATs exhibit different transmission signal power levels and thus different power levels of the reflected signals. In addition, switching between different RATs may enable the remote object detection system 100 to communicate with remote communication device 300, such as by communicating using cellular telephone networks. For example, communications between the transmitter TX or the first receiver RX1 and the remote communication device 300 may transition to a short-range communication link (e.g., WLAN) when the remote object detection system 100 moves closer to the remote communication device 300.

In various embodiments, the control unit 130 may be equipped with the input module 160, which may be used for a variety of applications. For example, the input module 160 may receive images or data from an onboard camera or sensor, or may receive electronic signals from other components (e.g., a payload). The input module 160 may receive an activation signal for causing actuators on the remote object detection system 100 to activate. In addition, the output module 170 may be used to activate other components (e.g., an energy cell, an indicator, a circuit element, and/or a sensor).

While the various components of the control unit 130 are illustrated as separate components, some or all of the components (e.g., the processor 150, the output module 170, and other units) may be integrated together in a single device or module, such as a system-on-chip module.

In accordance with various embodiments, electromagnetic simulation case studies in time domain were performed using a model including a transmitter (e.g., TX) and first receiver (e.g., RX1) sharing a first antenna, as well as three additional receivers (e.g., RX2, RX3, RX4) each with a separate antenna, and a remote object. The radio frequency of the transmitter signal was in the Bluetooth LE band (2.4 GHz−2.48 GHz, maximum transmitter power 4 dBm, and minimum receiver sensitivity −93dBm). All antennas were dipole type antennas with an arm length of 28 mm The shared first antenna was located at a coordinate origin (0 mm, 0 mm, 0 mm) The second receiver antenna was located at a second location (0 mm, 240 mm, 28 mm) The third receiver antenna was located at a third location (-240 mm, 0 mm, 28 mm) The fourth receiver antenna was located at a fourth location (0 mm, -240 mm, 28 mm) The first receiver antenna, the second receiver antenna, the third receiver antenna, and the fourth receiver antenna were dipole antennas, vertically polarized to provide a maximum antenna gain of 2 dB. The remote object consisted of a rectangular wire with a cross-sectional area having dimensions 20 mm×20 mm and a length of 5 m, consistent with a power line. The studies determined that such an object would have a radar cross-section (RCS) equal to 0.98. The remote object was located 1.5 m away from the transmitter antenna, extending lengthwise horizontally. Based on these conditions, a maximum detection range was estimated to be 17.5 m for the 4 dBm transmission power and 14 m for the 0 dBm transmission power.

Table 1 below shows the results from six electromagnetic simulation case studies (i.e., Case #1-#6), which use the above-noted parameters. Each case (#1)-(#6) shows coordinates for an actual center point to where a remote object was placed as compared to a location from the remote object detection system determined by using equations (11), (10D), and (13E). The electromagnetic simulation case studies (#1)-(#6) consistently show the determined location (i.e., center) to be very close to the actual location (i.e., center).

TABLE 1

| | x | y | z |
|---|---|---|---|
| Case #1 | | | |
| Actual center | 0 | 1.5 | 0 |
| Determined center | −0.06 | 1.5 | −0.01 |
| Case #2 | | | |
| Actual center | 0 | 1.5 | 0.5 |
| Determined center | −0.06 | 1.54 | 0.56 |
| Case #3 | | | |
| Actual center | 0 | 1.5 | −0.5 |
| Determined center | −0.05 | 1.54 | −0.51 |
| Case #4 | | | |
| Actual center | −1.06 | 1.06 | 0 |
| Determined center | −1.06 | 1.06 | 0.09 |
| Case #5 | | | |
| Actual center | −1.06 | 1.06 | 0.5 |
| Determined center | −1.07 | 1.07 | 0.57 |
| Case #6 | | | |
| Actual center | −1.06 | 1.06 | −0.5 |
| Determined center | −1.07 | 1.07 | −0.42 |

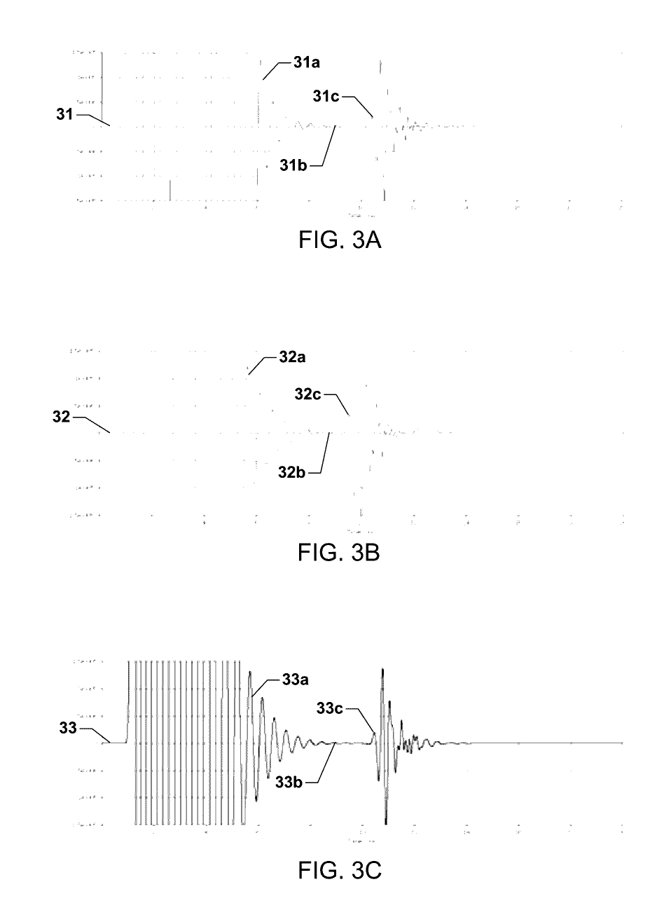

FIGS. 3A-3C illustrate graphs of response signals 31, 32, 33 received on the first, second, and the third receivers RX1, RX2, RX3 plotted against time. With reference to FIGS. 1-3C, the vertical axis represents the amplitude of recovered signals, the units of which depend on the unit of the transmitted signal and the horizontal axis represents time in nanoseconds (ns). The vertical axis represents the intensity of the signals 31, 32, 33 received from the moment the transmission signal is deployed. Each of the three receivers RX1, RX2, RX3 receives a direct pulse from the transmission signal almost immediately after it is emitted by the transmitter. The direct pulse is associated with the high amplitude bursts 31a, 32a, 33a noticeable at the beginning of the response signals 31, 32, 33. Subsequently, three receivers RX1, RX2, RX3 receive RF signal reflected off of the remote object. The reflected signals are associated with the smaller bursts 31C, 32C, 33C following the high amplitude bursts 31a, 32a, 33a and just after the delay periods 31b, 32b, 33b in which the signals drop to zero or near zero. Although the high amplitude bursts 31a, 32a, 33a are all received at roughly the same time, the smaller bursts 31d, 32d, 33d are received at different times consistent with the different distances traversed by the reflected RF signals received by each RF receiver. The first noticeable spike or increase in amplitude may be used to denote the precise time in which the reflected signals are received, although different criteria may be used for noting the reception time of each signal. Such a time differential as demonstrated in the graphs of the response signals 31, 32, 33 may be used to calculate a position of the remote object.

The RF receivers (e.g., RX1, RX2, RX3) may more accurately distinguish the directly transmitted signal (represented by the high amplitude bursts) from the reflected signals (represented by the smaller bursts) reflected off the remote object when the remote object is more than 1 meter away from the RF receivers. Different techniques for detecting remote objects (i.e., objects further than 1 m away from the RF receivers) may be used that take advantage of the early receipt of the directly transmitted signal at the RF receivers RX1, RX2, RX3.

Using BLE (Bluetooth Low Energy) transmission signals, the various embodiments may detect an object approximately 18 meters away. However, the BLE power levels are relatively low (<=4dBm—decibel-milliwatts). Similarly regular class 1 Bluetooth power levels <=20 dBM. In contrast, conventional WLAN transceivers transmit at power levels around 15 dBM. The various embodiments may use any RAT signals.

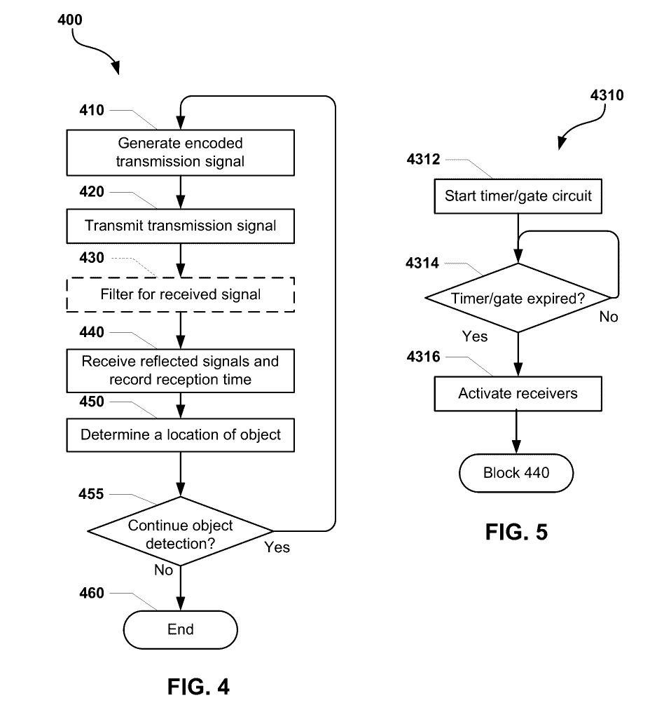

FIG. 4 illustrates a method 400 of detecting a location of a remote object (e.g., 10 in FIG. 1) according to various embodiments. With reference to FIGS. 1-4, operations of the method 400 may be performed by a processor of the remote object detection system 100. In various embodiments, the processor of the remote object detection system 100 may be included in the remote object detection system (e.g., processor 150) or in another computing device (e.g., remote communication device 300).

In block 410, the processor of the remote object detection system may generate a transmission signal, such as an encoded transmission signal. The processor may generate the encoded transmission signal directly, activate an encoder (e.g., 153) coupled to the transmitter (e.g., TX), or activate the transmitter to encode the transmission signals. Encoding transmission signals may enable a remote object detection system 100 to avoid being confused by signals from other remote object detection systems when several such systems are operating in the same area. Encoding included in the transmission signal may be recognized in the reflected signals by each RF receiver with reception times being recorded only for received reflected RF signals exhibiting a code of associated transmitter of the remote object detection system 100. Such encoding may also help to filter out noise or other signals that might otherwise be mistaken for reflected RF signals.

In block 420, the transmitter of the remote object detection system may transmit the transmission signal generated in block 410.

In optional block 430, the processor of the remote object detection system may optionally initiate one of various signal filtering techniques. Signal filtering may prevent unnecessary processing of signals not likely to be associated with actual reflected signals, including direct transmission signals. Various embodiments may employ a timer and/or gate circuit based on the transmitter sending the transmission signal in block 420. This process does not need to monitor for high amplitude bursts at any of the RF receivers. Instead, the RF receivers may be programmed to recognize the direct signal from the transmitter, which is a relatively stronger signal compared to reflected RF signals (e.g., the amplitude of the transmission signal may be an order of magnitude greater than the reflected signal). For example, the direct signal from the transmitter may have a characteristic pulse shape that is recognizable by each receiver. As soon as a receiver receives the characteristic pulse shape, the receiver may trigger a receiver-specific timer/gate circuit for measuring the time before which the reflected signal is not expected to be received.

Alternative optional filtering processes are described below with regard to the method 4310 (FIG. 5). The method 4310 may be performed in place of or in addition to the optional filtering method described above with regard to optional block 430.

In block 440, the RF receivers (e.g., RX1, RX2, RX3, RX4) of the remote object detection system may each receive a reflected signal (e.g., T_{RX1}, T_{RX2}, T_{RX3}, T_{RX4} in FIG. 1) of RF energy reflected off the remote object. The reception time of reflected signals may be determined and recorded and/or transmitted to a processor. The times at which each reflected signal was received may be stored in a memory (e.g., 151).

In block 450, a processor of or associated with the remote object detection system may determine the location of the remote object reflecting the RF energy based on the times that reflected signals were received by each of the RF receivers determined in block 440 knowing the locations or coordinate separation distances of the RF receivers (i.e., in relation to one another). For example, the location of the remote object may be determined using equations (11), (10D), and (13E) as described.

In determination block 455, the processor of the remote object detection system may determine whether to continue object detection. The determination of whether to continue may be based on whether an object is detected, the proximity of a detected object, received instructions regarding remote object detection, or other processes, protocols, or settings that may influence the determination whether to continue.

In response to determining that the remote object detection system should continue object detection (i.e., determination block 455=“Yes”), the processor may generate a new encoded transmission signal in block 410 and repeat the method 400 as described.

In response to determining that the remote object detection system should not continue object detection (i.e., determination block 455=“No”), the processor may end remote object detection in block 460.

FIG. 5 illustrates a method 4310 of filtering received signals, which may be used in place of or in addition to the filtering in optional block 430 of the method 400 (FIG. 4) according to various embodiments. With reference to FIGS. 1-5, operations of the method 4310 may be performed by a processor (e.g., 150) of the remote object detection system 100 and/or by the RF receivers RX1, RX2, RX3, RX4.

In block 4312, the processor of the remote object detection system may activate a timer/gate circuit in response to the transmitter sending the transmission signal in block 420 of the method 400. The processor may determine when the transmitter sent the transmission signal in at least one of two ways. The processor may determine the timing directly, since the processor may have activated the transmitter. Alternatively, the processor may determine the timing from indications of receipt of the transmission signal by the RF receivers. The RF receivers may recognize transmission signals by the high amplitude when such signals are received directly (versus reflected off of distant objects). Thus, the RF receivers may individually notify the processor when the transmission signal is received, or activate a timer/gate circuit directly within each RF receiver. Since the transmission signal is received by all the RF receivers at approximately the same time, only one receiver needs to communicate the arrival of the high amplitude bursts to the processor in some embodiments.

Once activated, the timer/gate circuit (e.g., 155) may use a predetermined delay period or count-down (e.g., 6 ns). As the timer/gate circuit counts down there is no need to monitor for the high amplitude bursts or any signals. In response to activity by the transmitter (i.e., transmitting signal), the high amplitude bursts and any subsequent signals may be ignored until after the timer/gate circuit expires. In determination block 4314, the processor of the remote object detection system, or a countdown timer within the timer/gate circuit may determine whether the timer/gate circuit has expired. In response to determining that the timer/gate circuit has not expired (i.e., determination block 4314=“No”), the processor may continue checking whether the timer/gate circuit has expired, or a countdown timer may continue counting down, in block 4314. Although the processor may receive indications from the RF receivers RX1, RX2, RX3 of premature signals received prior to the expiration of the timer/gate circuit, the processor may ignore (i.e., filter out) those premature signals. Optionally, the processor may wait a brief period before continuing to check (i.e., rechecking) whether the timer/gate circuit has expired in block 4314.

In response to determining that the timer/gate circuit has expired (i.e., determination block 4314=“Yes”), the processor and/or the timer/gate circuit may activate the RF receivers in block 4316 and continue with the method 400 by receiving reflected signals and recording reception times in block 440.

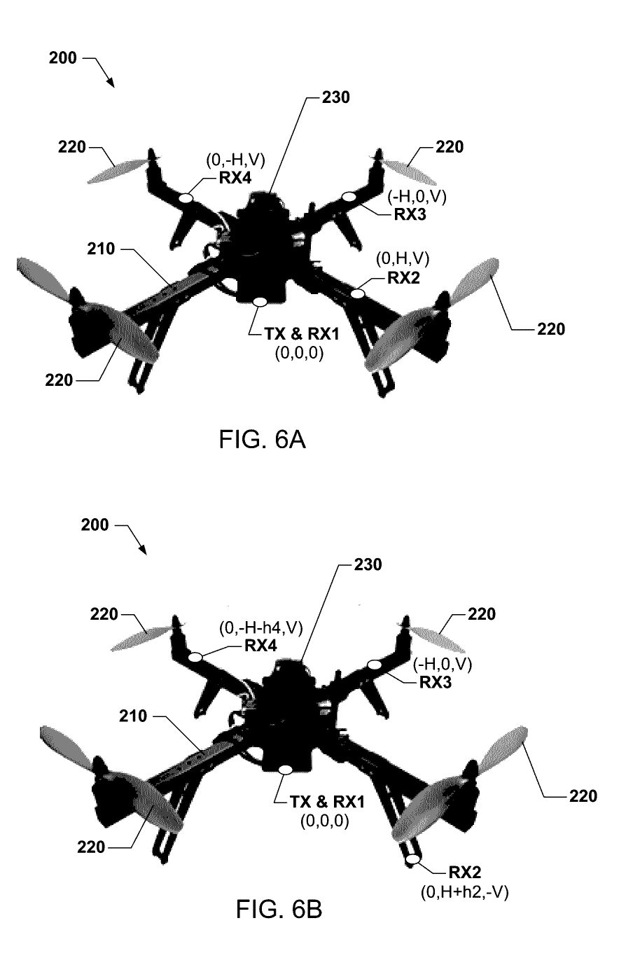

Various embodiments include a remote object detection system 200 in the form of a UAV, two examples of which are illustrated in FIGS. 6A and 6B. With reference to FIGS. 1-6B, the remote object detection system 200 includes a frame 210 (which may correspond to the frame 110 in some embodiments), a transmitter TX, a first receiver RX1, a second receiver RX2, a third receiver RX3, and a fourth receiver RX4. In addition, the remote object detection system 200 may include a number of propulsion units 220 and a control unit 230. The frame 210 may provide structural support for the propulsion units 220, the control unit 230, the transmitter TX, the first receiver RX1, the second receiver RX2, the third receiver RX3, the fourth receiver RX4, and most elements of the remote object detection system 200. UAVs have particular use for remote object detection, such as collision avoidance, landing, navigation, and the like. The frame 210 may include relatively long extension arms for supporting the propulsion units 220. Those separate extension arms, extending in different directions, may provide convenient locations for placing and remotely separating the first, second, third, and fourth receivers RX1, RX2, RX3, RX4.

With reference to FIG. 6A, the remote object detection system 200, the second, third, and fourth receivers RX2, RX3, RX4 are all equidistant from one another and offset the same radial distance from a vertical Z-axis, which radial distance corresponds to the horizontal offset H, similar to the remote object detection system 100. Similarly, the remote object detection system 200 has the second, third, and fourth receivers RX2, RX3, RX4 all equidistant from the transmitter TX and the first receiver RX1. Thus, the remote object detection system 200 includes the transmitter TX and the first receiver RX1, which are located at the transmitter location (0,0,0). The second receiver RX2 has a second receiver location (0,H,V). Similarly, the third receiver RX3 has a third receiver location (−H₂O,V). In addition, the fourth receiver RX4 has a fourth receiver location (0,−H,V).

With reference to FIG. 6B, the remote object detection system 200 still includes second, third, and fourth receivers RX2, RX3, RX4, but the second, third, and fourth receivers RX2, RX3, RX4 are not equidistant from one another due to difference in the horizontal offset and/or the vertical offset. In FIG. 6B, the remote object detection system 200 includes the transmitter TX and the first receiver RX1 located at the transmitter location (0,0,0) and the third receiver RX3 has a third receiver location (−H₂O,V). However, the second receiver RX2 has a second receiver location (0,H+h2,−V), which includes a larger horizontal offset and a negative vertical offset. In addition, the fourth receiver RX4 has a fourth receiver location (0,−H-h4,V), which includes a larger negative horizontal offset. Thus, for the remote object detection system 200 as illustrated in FIG. 6B, equations (3A) and (5A) may need to be adjusted to accommodate the larger offsets. Adjusting equations (3A) and (5A) would similarly adjust the further derivations accordingly.

With reference to FIGS. 1-6B, as used herein, the term “unmanned autonomous vehicle” (or “UAV”) refers to one of various types of autonomous vehicles (e.g., autonomous aircraft, land vehicles, waterborne vehicles, or a combination thereof) that may not utilize onboard, human pilots. The control unit 230 may include an onboard computing device configured to operate the remote object detection system 200 without remote operating instructions (i.e., autonomously), such as from a human operator or remote computing device. Alternatively, the onboard computing device may be configured to operate the remote object detection system 200 with some remote operating instruction or updates to instructions stored in a memory of the onboard computing device. The remote object detection system 200 may be propelled for movement in any of a number of known ways. For example, the propulsion units 220 may each include one or more propellers or jets that provide propulsion or lifting forces for the remote object detection system 200 and any payload carried by the remote object detection system 200 for travel or movement. In addition or alternatively, the remote object detection system 200 may include wheels, tank-tread, or other non-aerial/waterborne movement mechanisms to enable movement on the ground.

Although the remote object detection system 200 illustrated in FIGS. 6A and 6B is an aerial UAV, the embodiments are not limited to aerial vehicles, vehicles, or mobile devices and may be implemented in or on any frame. Various embodiments are described with reference to a UAV, particularly an aerial UAV, for ease of reference. However, the description of the remote object detection system 200 as a UAV is not intended to limit the scope of the claims to unmanned autonomous vehicles.

For ease of description and illustration, some detailed aspects of the remote object detection system 200 are omitted, such as wiring, frame structure interconnects, landing columns/gear, or other features that would be known to one of skill in the art. For example, while the remote object detection system 200 is shown and described as having a frame 210 having a number of support members or frame structures, the remote object detection system 200 may be constructed using a molded frame in which support is obtained through the molded structure. In the illustrated embodiments, the remote object detection system 200 has four propulsion units 220. However, more or fewer than four propulsion units to 220 may be used.

The various embodiments illustrated and described are provided merely as examples to illustrate various features of the claims. However, features shown and described with respect to any given embodiment are not necessarily limited to the associated embodiment and may be used or combined with other embodiments that are shown and/or described. Further, the claims are not intended to be limited by any one example embodiment.

The foregoing method descriptions and the process flow diagrams are provided merely as illustrative examples and are not intended to require or imply that the steps of the various embodiments must be performed in the order presented. As will be appreciated by one of skill in the art the order of operations in the foregoing embodiments may be performed in any order. Any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a processor. As used herein, the term “processor” refers to a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Various embodiments detect an object using RF signals that do not require high energy expenditures. In addition, the object detection system described herein takes advantage of RF technologies already included in the underlying apparatus on which the object detection system is installed (e.g., Bluetooth LE, Wi-Fi, or other WLAN technologies). Using RF technologies already included and that do not consume a lot of energy may ensure a low-cost object detection system. Various embodiments avoid beam forming and/or unidirectional detection, while providing omnidirectional detection (i.e., in all directions). Conventional radar systems are unidirectional, which requires them to move or rotate in order to detect signals from multiple directions. In contrast, the various embodiments are configured to detect signals in all directions, which means the UAV does not need to change position in order to detect an object. Various embodiments use either technology that is already existing on many UAVs, which reduces redundancy and can minimize cost and maintenance, or provides a low-cost solution using inexpensive technologies that also do not consume a great deal of power, such as WLAN devices.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of determining a location of a remote object, comprising:
transmitting, from a transmitter at a transmitter location on a frame, a transmission signal;
receiving, at a first receiver, a second receiver, a third receiver, and a fourth receiver respectively a first reflected signal, a second reflected signal, a third reflected signal, and a fourth reflected signal, wherein each of the first, second, third, and fourth reflected signals are reflections of the transmission signal off the remote object, and wherein the first, second, third, and fourth receivers are disposed on the frame separated from one another respectively at a first receiver location, a second receiver location, a third receiver location, and a fourth receiver location on the frame;
determining times at which the first, second, third, and fourth reflected signals are received respectively by the first, second, third, and fourth receivers; and
determining, in a processor, the remote object's location based on the determined times at which the first, second, third, and fourth reflected signals were received respectively at the first, second, third, and fourth receivers and known locations of the first, second, third, and fourth receivers.

2. The method of claim 1,
wherein the transmission signal includes encoding, and
wherein determining times at which the first, second, third, and fourth reflected signals are received respectively by the first, second, third, and fourth receivers comprises:
determining whether the received first reflected signal, received second reflected signal, received third reflected signal, and received fourth reflected signal include the encoding; and
determining times at which the first, second, third, and fourth reflected signals, including the encoding, are received respectively by the first, second, third, and fourth receivers.

3. The method of claim 1, further comprising:
receiving, at the first receiver, the second receiver, the third receiver, and the fourth receiver respectively, a first direct signal, a second direct signal, a third direct signal, and a fourth direct signal, wherein each of the first, second, third, and fourth direct signals are direct receptions of the transmission signal,
wherein determining, in a processor, the remote object's location based on the determined times at which the first, second, third, and fourth reflected signals were received respectively at the first, second, third, and fourth receivers comprises determining the remote object's location based on time differences between times at which the first, second, third, and fourth direct signals were each received and the times at which the first, second, third, and fourth reflected signals were each received.

4. The method of claim 3, further comprising:
activating a first timer, a second timer, a third timer, and a fourth timer respectively in response to receiving the first, second, third, and fourth direct signal; and
activating the first, second, third and fourth receivers to receive reflected signals following expiration of the respective first, second, third and fourth timer.

5. The method of claim 1, wherein the processor activates a timer/gate circuit that ignores other signals received at the first, second, third, and fourth receivers within a predetermined period from when the timer/gate circuit is activated.

6. The method of claim 1, further comprising:
receiving at the processor times at which the first, second, third, and fourth reflected signals are each received.

7. The method of claim 1, wherein transmitting the transmission signal comprises transmitting a wireless local area network (WLAN) communication signal.

8. The method of claim 1, wherein transmitting the transmission signal comprises transmitting a Bluetooth LE communication signal.

9. A device implemented on a frame for detecting a location of a remote object, comprising:
a transmitter coupled to the frame and configured to transmit a transmission signal;
a first receiver coupled to the frame at a first receiver location and configured to receive a first reflected signal generated by a reflection of the transmission signal off the remote object;
a second receiver coupled to the frame at a second receiver location and configured to receive a second reflected signal generated by the reflection of the transmission signal off the remote object;
a third receiver coupled to the frame at a third receiver location and configured to receive a third reflected signal generated by the reflection of the transmission signal off the remote object;
a fourth receiver coupled to the frame at a fourth receiver location and configured to receive a fourth reflected signal generated by the reflection of the transmission signal off the remote object, wherein the first, second, third, and fourth receivers are disposed remote from one another; and
a processor coupled to the transmitter and the first, second, third, and fourth receivers, wherein the processor is configured to:
determine the remote object's location based on times that the first, second, third, and fourth reflected signals are received respectively at the first, second, third, and fourth receiver locations.

10. The device of claim 9, wherein the first, second, third, and fourth receivers are each connected to separate omnidirectional antennas.

11. The device of claim 9, wherein the transmitter is configured to transmit a wireless local area network (WLAN) communication signal as the transmission signal.

12. The device of claim 9, wherein the transmission signal is a Bluetooth LE communication signal.

13. The device of claim 9, wherein the transmitter and the first receiver share an antenna.

14. The device of claim 9, wherein the frame is part of an unmanned autonomous vehicle (UAV).

15. The device of claim 14, wherein at least three of the first, second, third, and fourth receivers are disposed on separate extension arms of the UAV extending in different directions, wherein the extension arms each support a separate propulsion unit of the UAV.

16. A device for detecting a location of a remote object, comprising:
a frame;
means for transmitting a transmission signal coupled to the frame;
means for receiving a first reflected signal generated by a reflection of the transmission signal off the remote object, wherein the means for receiving the first reflected signal is coupled to the frame at a first receiver location;
means for receiving a second reflected signal generated by the reflection of the transmission signal off the remote object, wherein the means for receiving the second reflected signal is coupled to the frame at a second receiver location;
means for receiving a third reflected signal generated by the reflection of the transmission signal off the remote object, wherein the means for receiving the third reflected signal is coupled to the frame at a third receiver location;
means for receiving a fourth reflected signal generated by the reflection of the transmission signal off the remote object, wherein the means for receiving the fourth reflected signal is coupled to the frame at a fourth receiver location, wherein the first, second, third, and fourth receivers are disposed remote from one another; and
means for determining the remote object's location based on times that the first, second, third, and fourth reflected signals are received respectively at the first, second, third, and fourth receiver locations.

17. A non-transitory processor-readable storage medium having stored thereon processor-executable instructions configured to cause a processor of a device to perform operations for detecting a location of a remote object comprising:
transmitting, using a transmitter at a transmitter location on a frame, a transmission signal;
receiving, via a first receiver, a second receiver, a third receiver, and a fourth receiver respectively a first reflected signal, a second reflected signal, a third reflected signal, and a fourth reflected signal, wherein each of the first, second, third, and fourth reflected signals are reflections of the transmission signal off the remote object, wherein the first, second, third, and fourth receivers are disposed remote from one another respectively at a first receiver location, a second receiver location, a third receiver location, and a fourth receiver location each on the frame;
determining times at which the first, second, third, and fourth reflected signals are received respectively by the first, second, third, and fourth receivers; and
determining the remote object's location based on the determined times at which the first, second, third, and fourth reflected signals were received respectively at the first, second, third, and fourth receivers and known locations of the first, second, third, and fourth receivers.

18. The non-transitory processor-readable storage medium of claim 17, wherein the stored processor-executable instructions are configured to cause the processor to perform operations such that the transmission signal includes encoding and determining times at which the first, second, third, and fourth reflected signals are received respectively by the first, second, third, and fourth receivers comprises:
determining whether the received first reflected signal, second reflected signal, third reflected signal, and fourth reflected signal include the coding; and
determining times at which the first, second, third, and fourth reflected signals including the coding are received respectively by the first, second, third, and fourth receivers.

19. The non-transitory processor-readable storage medium of claim 17, wherein the stored processor-executable instructions are configured to cause the processor to perform operations further comprising:
receiving, via the first receiver, the second receiver, the third receiver, and the fourth receiver respectively, a first direct signal, a second direct signal, a third direct signal, and a fourth direct signal, wherein each of the first, second, third, and fourth direct signals are direct receptions of the transmission signal,
wherein the stored processor-executable instructions are configured to cause the processor to perform operations such that determining the remote object's location based on the determined times at which the first, second, third, and fourth reflected signals were received respectively at the first, second, third, and fourth receivers comprises determining the remote object's location based on time differences between when the determined times at which the first, second, third, and fourth direct signals were each received and times at which the first, second, third, and fourth reflected signals were each received.

20. The non-transitory processor-readable storage medium of claim 19, wherein the stored processor-executable instructions are configured to cause the processor to perform operations further comprising:
activating a first timer, a second timer, a third timer, and a fourth timer respectively in response to receiving the first, second, third, and fourth direct signal; and
activating the first, second, third and fourth receivers to receive reflected signals following expiration of the respective first, second, third and fourth timer.

21. The non-transitory processor-readable storage medium of claim 17, wherein the stored processor-executable instructions are configured to cause the processor to perform operations such that the processor activates a timer/gate circuit that ignores other signals received at the first, second, third, and fourth receivers within a predetermined period from when the timer/gate circuit is activated.

22. The non-transitory processor-readable storage medium of claim 17, wherein the stored processor-executable instructions are configured to cause the processor to perform operations further comprising:
receiving times at which the first, second, third, and fourth reflected signals are each received.

23. The non-transitory processor-readable storage medium of claim 17, wherein the stored processor-executable instructions are configured to cause the processor to perform operations such that transmitting the transmission signal comprises transmitting a wireless local area network (WLAN) communication signal.

24. The non-transitory processor-readable storage medium of claim 17, wherein the stored processor-executable instructions are configured to cause the processor to perform operations such that transmitting the transmission signal uses a Bluetooth LE communication signal.
